(19) United States
(12) Patent Application Publication
(10) Pub. No.: US 2007/0261243 A1
(43) Pub. Date: Nov. 15, 2007

(54) METHOD FOR MAKING PLATE TYPE HEAT PIPE

(76) Inventors: Hsiu-Wei Yang, Taipei (TW); Pei-Pei Ding, Taipei (TW); Jao-Ching Lin, Taipei (TW); Wen-Hwa Yu, Taipei (TW)

Correspondence Address: G. LINK CO., LTD, 3550 BELL ROAD, MINOOKA, IL, 60447, US

(21) Appl. No.: 11/382,820

(22) Filed: May 11, 2006

(51) Int. Cl. B21D 53/02; B23P 6/00; B23P 15/26

(52) U.S. Cl. 29/890.03; 29/890.032; 29/890.054

(57) ABSTRACT

A method for making a plate type heat pipe includes following steps: (A) providing a metallic hollow casing unit, which includes a first casing member with a first joining part at the periphery thereof and a second casing member with a second joining part at the periphery thereof corresponding to and matching the first joining part to form a containing space, and an injection part being arranged at one of the casing members for the containing space communicating with outside; (B) forming a bonding layer on a surface of at least one of the joining parts facing the other one of the joining parts with a treatment of gas phase deposit; and (C) the first joining part being disposed on the second joining part and being heated up to melt the bonding layer. The bonding layer is adhered to the second joining part with consistent thickness to allow the first joining part engaging with the second joining part air-tightly.

### BACKGROUND OF THE INVENTION

1. Field of the Invention

The present invention is related to a method for making a plate type heat pipe and particularly to a method, which is capable of enhancing air-tightness of a plate type heat pipe with treatment of gas phase deposit.

2. Brief Description of the Related Art

Electronic components such as central processing unit (CPU) providing higher operation speed results in higher heat generation rate. In order to solve problem of heat dissipation, various heat dissipation components are developed. Cooling fins, cooling fan, heat pipe and combination of the preceding components are typical heat dissipating devices available. For instance, the conventional heat dissipating device guides the generated heat from such as CPU to a radiator or a high heat metal conduction block via outer layer of package of the heat generating component. Then, the heat pipe is employed to transmit the heat to cooling fins or cooling fan for being removed outward.

Due to the portable electronic device such as laptop computer being made with a trend to pursue lightness, thinness, shortness and smallness, problem of heat dissipation becomes getting serious and the conventional heat dissipating device has faced a bottleneck that it is hard to promote effect of heat dissipation.

Hence, the plate type heat pipe has been developed to accommodate the portable electronic device as a good heat dissipating device. The plate type heat pipe applies the same operational principle as the traditional heat pipe with which working fluid sealed in the plate type heat pipe is heated up to occur change of phase and perform heat exchange with latent heat. That is, when a portion of the plate type heat pipe contacts heat source of the electronic component, the working fluid near the portion is under a condition of saturated vapor pressure such that it is easy to evaporate as steam rapidly once heat is absorbed by the working fluid. Meanwhile, pressure of the steam is higher than rest part of the plate type heat pipe so that the steam moves rapidly to other places for condensation and heat of the steam transmits to the casing of the plate type heat pipe and dissipates to the atmosphere via large area of the casing or the cooling fins attached to the surface of the casing. Besides, the steam condenses as liquid after releasing latent heat and moves back to the original place via capillary device to complete a working cycle. The plate type heat pipe executes two dimensional heat transmissions instead of one dimensional heat transmission performed with the traditional heat pipe. It means the plate type heat pipe provides better capacity of heat dissipation than the traditional heat pipe.

Nevertheless, air-tightness of the plate type casing is an important key point to influence performance of the plate type heat pipe. Unfavorable air-tightness affects saturated vapor pressure of the working liquid sealed in the plate type heat pipe significantly and the saturated vapor pressure further affects gas-liquid phase change of the working liquid such that effect of heat dissipation is incapable of being enhanced.

Referring to FIGS. 1 and 2, the conventional method for making a plate type heat pipe includes the following steps:

First of all, a hollow casing unit 2 made of copper or aluminum is provided and the casing unit 2 is composed of a first casing member 21 and a second casing member 22 opposite to each other and a containing space 26 is formed once the two casing members 21, 22 engage with each other. The first casing member 21 has a first joining part 211 at the periphery thereof and the second casing member 22 has a second joining part 221 at the periphery thereof corresponding to the second joining part 221. Either the first casing member 21 or the second casing member 22 has a through hole 24 communicating with the containing space 26. The casing unit 2 has a rectangular shape illustrated in FIG. 2.

Next, the second joining part 221 has a surface, which faces the first joining part 211, is plated with a metallic bonding layer 25 in step 11.

Then, a capillary device 23 is placed in the containing space 26 in step 12.

Further, the first joining part 211 is disposed on the second joining part 221 for the first casing member 21 being located at the second casing member 22 in step 13.

Further, the bonding layer 25 is heated up to a state of melting for engaging the first joining part 211 and the second joining part 221 together in step 14.

Further, the working liquid is injected into the containing space 26 via the through hole 24 and residue air inside the containing space 26 is sucked out via the through hole 24 afterward in step 15.

Finally, the through hole is blocked and sealed in step 16.

In this way, the plate type heat pipe can be fabricated completely.

However, because the bonding layer is formed with plating, it is hard to have a consistent thickness of the bonding layer and the inconsistent thickness is more serious especially in case of the surface of the casing unit 2 being larger.

Treatment of plating is processed by that the plated metal object is immerged in a solution containing positive ions of plating metal and the plated metal object is charged with negative voltage according to principle of electrical-chemistry such that the positive metal ions neutralize electrons on the plated metal object to reduce and deposit on the surface of the plated object.

But, thickness of the plating metal layer made with the principle of electrical-chemistry is varied depending on configuration of the plated object. Because when the plated object is charged with negative voltage, the electrons are capable of congregating at the sharp corners of the plated object and it results in more positive metal ions being reduced at the sharp corners and less metal ions being reduced at the rest spots of the plated object. That is, thicker plating layer is at the sharp corners and thinner plating layer is at the rest spots.

Hence, once the treatment of plating is applied to make the bonding layer 25, the bonding layer 25 is thicker than the rest spots of the second joining part 221. The bonding layer 25 with inconsistent thickness is hard for the first joining part 211 to engage with the second joining part 221 tightly. In this way, the air-tightness of the whole plate type heat pipe becomes deteriorated and performance thereof is affected as well.

Besides, the metallic material available for making the bonding layer 25 is restricted if the treatment of plating is employed to fabricate the bonding layer 25. Due to the treatment of plating being performed with electrical-chemistry to reduce metallic ions on the surface of the plated object in the solution, capability of reduction of the metallic ions is related to the reduction potential thereof and different metals have different reduction potentials. Hence, in order to have the bonding layer 25 being made of multi-metallic alloy, it is necessary to add proper complexing agents into the plating solution for regulating reduction potentials of different metals. But, it is hard to control proper proportions of the metals even if the complexing agents are added. Generally, in case of the alloy being composed of two metals, the bonding layer can be formed with the treatment of plating under complicated control in spite of proportions of the metals in the alloy being not easy to control. As for the alloy being composed of triple metals or more, it is difficult to form the bonding layer with the treatment of plating.

Furthermore, in order to meet trend of environmental protection, the traditional alloy with tin and lead for making the bonding layer 25 is replaced by an alloy with tin, silver and copper gradually and it is obvious that the treatment of plating is hard to form the bonding layer 25 with an alloy of triple metals.

### SUMMARY OF THE INVENTION

Accordingly, an object of the present invention is to provide a method for making a plate type heat pipe with which air-tightness of the heat pipe can be enhanced and bonding layer can be formed with a multi-metallic alloy.

The method for making a plate type heat pipe according to the present invention includes:

(A) providing a metallic hollow casing unit, which includes a first casing member with a first joining part at the periphery thereof and a second casing member with a second joining part at the periphery thereof corresponding to and matching the first joining part to form a containing space, and an injection part being arranged at one of the casing members for the containing space communicating with outside;

(B) forming a bonding layer on a surface of at least one of the joining parts facing the other one of the joining parts with a treatment of gas phase deposit; and

(C) allowing the first joining part being disposed on the second joining part to locate the first casing member at the second casing member and heating up the first joining part, the second joining part and the bonding layer.

Wherein, the bonding layer provides a consistence thickness such that the first joining part is capable of engaging with the second joining part tightly for the plate type heat pipe being in a state of air-tight.

### BRIEF DESCRIPTION OF THE DRAWINGS

The detail structure, the applied principle, the function and the effectiveness of the present invention can be more fully understood with reference to the following description and accompanying drawings, in which:

FIG. 1 is a flow chart of the conventional method for making a flat type heat pipe;

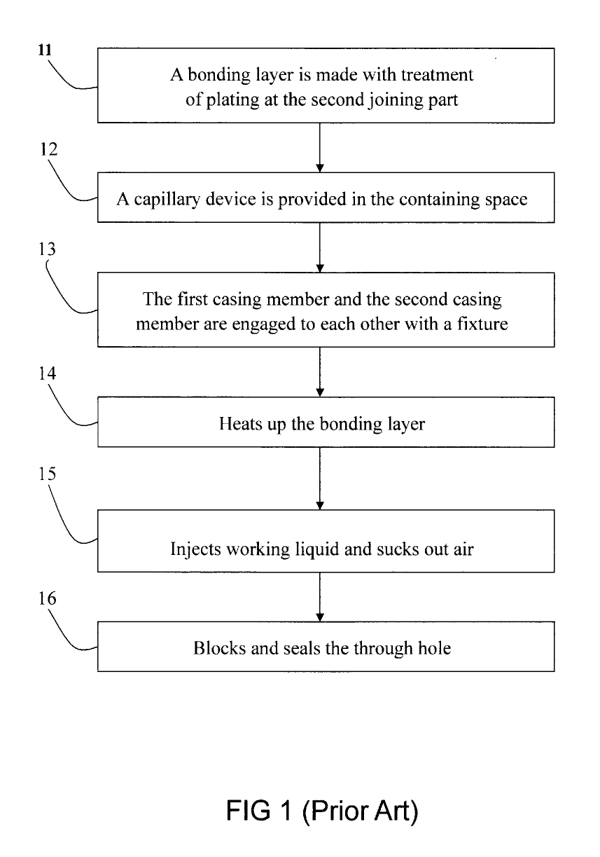

FIG. 2 is an exploded perspective view of the conventional flat type heat pipe;

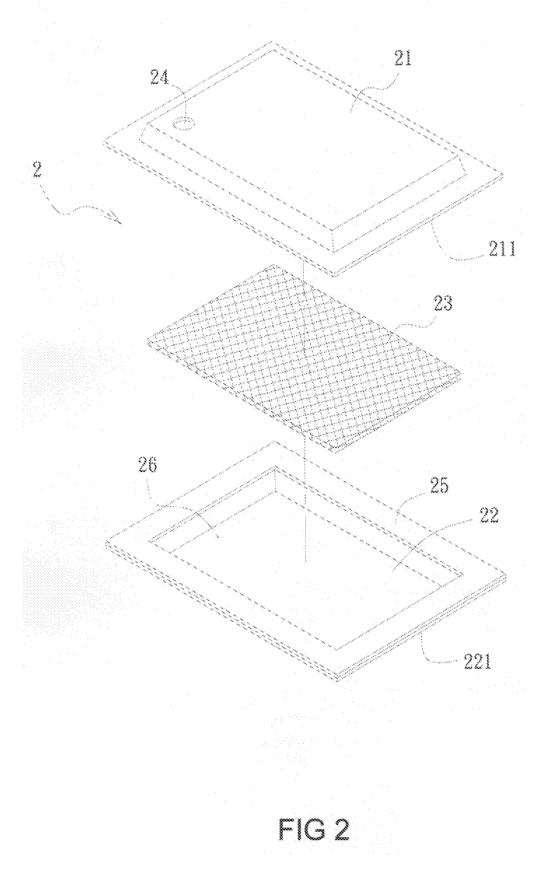

FIG. 3 is a flow chart of a method for making a flat type heat pipe according to the present invention;

FIG. 4 is an exploded sectional view of the flat type heat pipe made by means of a preferred embodiment of the method according to the present invention; and

FIG. 5 is a sectional view of the flat type heat pipe with a fixture employed in the preferred embodiment of the method according to the present invention.

### DETAILED DESCRIPTION OF THE INVENTION

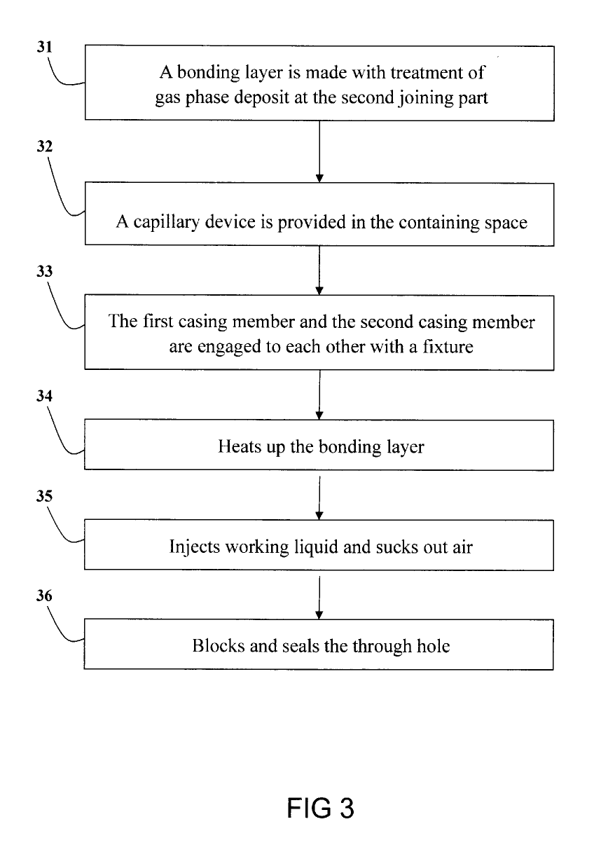

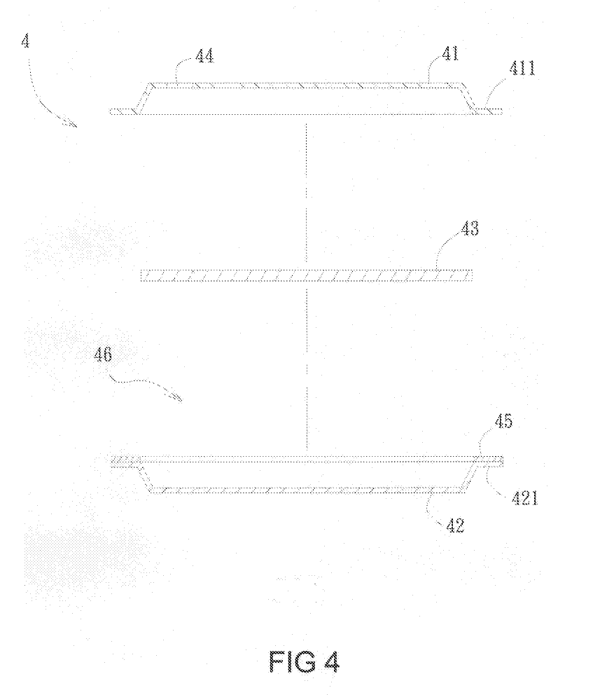

Referring to FIGS. 3 and 4, a method for making a flat type heat pipe according to the invention includes following steps:

First of all, a hollow casing unit 4, which is made of copper or aluminum, is provided and the hollow casing unit 4 has a first casing member 41 and a second casing member 42 to be joined to each other and form a containing space 46. The first casing member 41 has a first joining part 411 at the periphery thereof and the second casing member 42 has a second joining part 421 at the periphery thereof corresponding to the first joining part 411. The first casing member 41 further has an injecting part 44, which is a through hole, communicating with the containing space 46. Although the casing unit 4 is rectangular shape illustrated in the preferred embodiment, it can be any shapes except rectangular shape. The injection part 44 is used for the working fluid flowing into the containing space 46 and for the air being sucked outward. Hence, the injection part 44 is capable of being disposed at a specific position based on design preference if the containing space 46 can communicate with the atmosphere.

Next, a bonding layer 45 is formed with method of gas phase deposit on the second joining part 421 at the surface being opposite to the first joining part 411 in step 31. The bonding layer 45 is made of metallic material. The bonding layer 45 can be formed on the first joining part 421 at the surface being opposite to the second joining part 411 instead or both of the surfaces are formed with the bonding layer 45 respectively instead.

The method of gas phase deposit is conducted under an environment of vacuum or semi-vacuum by means of physical or chemical way to resolve metallic material as gaseous metallic atoms or metallic atom clusters such that the gaseous metallic atoms or the metallic atom clusters scatter over the surface of a plated object in the environment of vacuum or semi-vacuum and form a plated layer adhering the surface.

The method of gas phase deposit is typically implemented by means of the physical way. The method of gas phase deposit with physical way means the metallic material is resolved by means of physical ways such as steam plating, with which the metallic material is satirized as metallic atoms or atom clusters with high temperature or high energy, or splash plating, with which working gas is ionized with electric field and the ionized working gas hits a surface of metallic solid material and gaseous metallic atoms or clusters are splashed out form the surface.

Contrast to the conventional method of plating making non-uniform thickness of bonding layer, thickness of the bonding layer 45, which is formed by the method of gas phase deposit with physical way, is uniform because the thickness of the bonding layer 45 is incapable of being affected by configuration of the second joining part 421 due to the metallic material atoms carrying no electric charges.

In addition, because the method of the invention conducts with physical way to resolve the metallic material as the gaseous metallic atoms or the metallic atom clusters scattering over the surface of a plated object in the environment of vacuum or semi-vacuum and forming the bonding layer 45 adhering the surface, the gradients of the metallic material can be arranged as desired without any restrictions the conventional method of plating usually encounters.

Therefore, the metallic material of the bonding layer 45 can be selected from tin, silver, copper or any combinations of the preceding metals. Tin, lead or combination of preceding metals can be selected as the metallic material of the bonding layer 45. Even more, tin, bismuth or combination of the preceding metals can be selected as the metallic material of the bonding layer 45.

Further, step 32 provides a capillary member 43, which is placed in the containing space 46 constituted by the first casing member 41 and the second casing member 42.

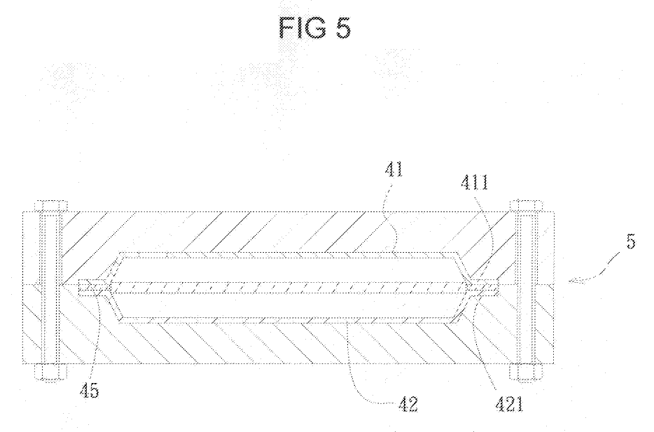

Referring to FIGS. 3 and 5, step 33 is in that the first joining part 411 is disposed on the second joining part 421 to locate the first casing member 41 to the second casing member 42 and a fixture 5 is employed to secure relative position of the first and second casing members 41, 42.

Step 34 is to heat up the first and second joining parts 411, 421 and the bonding layer 45 for eutectic bonding being performed between the first and second joining parts 411, 421 and the bonding layer 45 and air-tight joint between the first joining part 411 and the second joining part 421 can be obtained

Referring to FIG. 4 in company with FIG. 3, step 35 is to inject the working liquid into the containing space 46 via the injection part 44 of the casing unit 4. Then, residue air in the containing space 46 with working liquid is sucked out.

Finally, step 36 is to block and seal the injection part 44.

It is appreciated that a method for making flat type heat pipe according to the present invention allows the bonding layer 45 being arranged on the second joining part 421 with consistent thickness and without being affected by the configuration of the second joining part 421 such that the first joining part 411 is capable of joining the second joining part 411 tightly to promote air-tightness of the integral flat type heat pipe. Further, metallic gradients of the bonding layer 45 can be any combinations of alloy without restriction.

While the invention has been described with referencing to the preferred embodiment thereof, it is to be understood that modifications or variations may be easily made without departing from the spirit of this invention, which is defined by the appended claims.

What is claimed is:

1. A method for bonding a hollow casing unit, comprising following steps:
(A) providing a first casing member, which has a first joining part at the periphery thereof, and a second casing member, which matches with the first casing member and has a second joining part at the periphery thereof corresponding to the first joining part;
(B) forming a bonding layer on a surface of at least one of the joining parts facing the other one of the joining parts with a treatment of gas phase deposit; and
(C) allowing the first joining part being disposed on the second joining part to locate the first casing member at the second casing member and heating up the first joining part, the second joining part and the bonding layer.

2. The method for bonding a hollow casing unit as defined in claim 1, wherein the treatment of gas phase deposit in step (B) refers to physical treatment of gas phase deposit.

3. The method for bonding a hollow casing unit as defined in claim 2, wherein the physical treatment of gas phase deposit refers to vapor plating.

4. The adjustable device for balancing a fan as defined in claim 1, wherein the inner ring is joined to a spindle.

5. The method for bonding a hollow casing unit as defined in claim 1, wherein the first casing member and the second casing member are made of copper or aluminum.

6. The method for bonding a hollow casing unit as defined in claim 1, wherein the bonding layer in step (B) is formed at the second joining part to face the surface of the first joining part.

7. The method for bonding a hollow casing unit as defined in claim 1, wherein a fixture is provided in step (C) to secure the first casing member and the second casing member.

8. The method for bonding a hollow casing unit as defined in claim 1, wherein the bonding layer is made of metallic material.

9. The method for bonding a hollow casing unit as defined in claim 8, wherein the metallic material is selected from tin, silver, copper or any combinations of the preceding metals.

10. A method for making a plate type heat pipe, comprising following steps:
(A) providing a metallic hollow casing unit, which includes a first casing member with a first joining part at the periphery thereof and a second casing member with a second joining part at the periphery thereof corresponding to and matching the first joining part to form a containing space, and an injection part being arranged at one of the casing members for the containing space communicating with outside;
(B) forming a bonding layer on a surface of at least one of the joining parts facing the other one of the joining parts with a treatment of gas phase deposit; and
(C) allowing the first joining part being disposed on the second joining part to locate the first casing member at the second casing member and heating up the first joining part, the second joining part and the bonding layer.

11. The method for making a plate type heat pipe as defined in claim 10, wherein a capillary device is formed in the containing space in step (B).

12. The method for making a plate type heat pipe as defined in claim 10, wherein a fixture is provided in step (C) to secure the first casing member and the second casing member after the first casing member is located at the second casing member.

13. The method for making a plate type heat pipe as defined in claim 10 further comprises a step (D) to fill working liquid into the containing space via the injection part.

14. The method for making a plate type heat pipe as defined in claim 10 further comprises a step (E) to suck residue gas in the containing space outward via the injection part.

15. The method for making a plate type heat pipe as defined in claim 10 further comprises a step (F) to block and seal the injection part.

16. The method for making a plate type heat pipe as defined in claim 10, wherein the treatment of gas phase deposit in step (B) refers to physical treatment of gas phase deposit.

17. The method for making a plate type heat pipe as defined in claim 16, wherein the physical treatment of gas phase deposit in step (B) refers to vapor plating.

19. The method for making a plate type heat pipe as defined in claim 16, wherein the physical treatment of gas phase deposit in step (B) refers to splash plating.

20. The method for making a plate type heat pipe as defined in claim 10, wherein the bonding layer is made of metallic material.

21. The method for making a plate type heat pipe as defined in claim 20, wherein the metallic material is selected from tin, silver, copper or any combinations of the preceding metals.

22. The method for making a plate type heat pipe as defined in claim 10, wherein the injection part is a through hole at the first casing member.
